(19) United States
(12) Patent Application Publication
(10) Pub. No.: US 2019/0013710 A1
(43) Pub. Date: Jan. 10, 2019

(54) Rotary Electric Machine

(71) Applicant: Hitachi Automotive Systems Engineering, Ltd., Hitachinaka-shi, Ibaraki (JP)

(72) Inventors: Shozo KAWASAKI, Hitachinaka (JP); Hiroshi KANAZAWA, Hitachinaka (JP); Yasunaga HAMADA, Hitachinaka (JP); Kenji NAKAYAMA, Hitachinaka (JP); Koichi KASHIWA, Hitachinaka (JP); Masahiro HOSOYA, Hitachinaka (JP)

(21) Appl. No.: 16/065,878

(22) PCT Filed: Dec. 2, 2016
(86) PCT No.: PCT/JP2016/085834

§ 371 Date: Jun. 25, 2018

(30) Foreign Application Priority Data
Dec. 25, 2015 (JP) 2015-252798

(51) Int. Cl. H02K 3/18; H02K 3/28; H02K 1/14

(52) U.S. Cl. CPC H02K 3/18; H02K 1/148; H02K 3/28

(57) ABSTRACT

Provided is a rotary electric machine in which lengths of routing portions of coil terminals are made uniform and a coil terminal portion is downsized. A rotary electric machine includes a rotor and a stator, the stator including teeth each wound with a coil, in which the coil consists of a first coil set and a second coil set, each of the first coil set and the second coil set is continuously wound around the two teeth, and includes a first coil terminal, and a second coil terminal to which a routing portion is formed, the first coil terminal of each of the first coil set and the second coil set is directly connected to the second coil terminal of another of the first coil set and the second coil set, the first coil terminal and the second coil terminal of each of the first coil set and the second coil set are arranged on an identical coil end, and the second coil terminal of each of the first coil set and the second coil set is arranged not to cross any other coil terminal in an axial direction.

### TECHNICAL FIELD

The present invention relates to a rotary electric machine.

### BACKGROUND ART

A rotary electric machine mounted in an automobile is required to have not only output performance but also to be downsized due to a limited space for mounting. In a case of a three-phase brushless motor, an inner rotor type is used in which the outer stator is a stator including a plurality of coils wound and the inner rotor is a rotor on which a magnet is arranged on the outer circumference. In the stator, to improve the output performance by winding the coils with high density, and to efficiently wind the coils, a split core is adopted obtained by dividing the stator core into a plurality of cores.

In a case where the split core is adopted, lead wire portions must be electrically connected together to connect a winding start portion and a winding end portion wound around each tooth portion. When there are many electrical connection points, a lot of labor and parts are required for manufacturing. To reduce the number of electrical connection points, continuous winding is adopted.

For example, PTL 1 discloses a technique of performing continuous winding to a plurality of split cores in the same direction.

In addition, PTL 2 discloses a technique of connecting back yoke portions of adjacent split cores to each other and performing continuous winding to two adjacent split cores as one set.

### CITATION LIST

### Patent Literature

PTL 1: JP 2006-50690 A

PTL 2: JP 2010-246352 A

### SUMMARY OF INVENTION

### Technical Problem

In the techniques disclosed in PTL 1 and PTL 2, continuous winding is performed in the same direction, so that the points where the coil terminal can be electrically connected are limited. Further, since the coil terminals are arranged to be distributed, in a case where the coils are electrically connected together by star connection, lengths of the coil terminals also become non-uniform when the neutral points are bundled at one point, and an additional part is required for equalization. Even in a case where continuous winding is not performed, it is necessary to add a part to connect the winding start portion and the winding end portion wound around each tooth portion.

Therefore, it is an object of the present invention to provide a rotary electric machine in which lengths of routing portions of the coil terminals are made uniform and a coil terminal portion is downsized.

### Solution to Problem

To solve the above problems, for example, a configuration described in claims is adopted.

The present application includes a plurality of means for solving the above problems, and its examples include a rotary electric machine including a rotor and a stator, the stator including teeth each wound with a coil, in which the coil consists of a first coil set and a second coil set, each of the first coil set and the second coil set is continuously wound around the two teeth, and includes a first coil terminal, and a second coil terminal to which a routing portion is formed, the first coil terminal of each of the first coil set and the second coil set is directly connected to another of the first coil set and the second coil set, the first coil terminal and the second coil terminal of each of the first coil set and the second coil set are arranged on an identical coil end, and the second coil terminal of each of the first coil set and the second coil set is arranged not to cross any other coil terminal in an axial direction.

### Advantageous Effects of Invention

According to the present invention, it is possible to uniformize resistance of the coil terminal portion by uniformizing the lengths of the routing portions of the coil terminals, and to provide a rotary electric machine in which the coil terminal portion is downsized by equalized arrangement of the routing portions of the coil terminals.

Problems, configurations, and effects other than those described above will be clarified from description of embodiments below.

### BRIEF DESCRIPTION OF DRAWINGS

FIG. 1 is a cross-sectional view of a rotary electric machine according to an embodiment of the present invention.

FIG. 2 is a schematic diagram illustrating a coil set according to a first embodiment of the present invention.

FIG. 3 is a schematic diagram illustrating an arrangement of a U-phase coil set according to the first embodiment of the present invention.

FIG. 4 is a schematic diagram illustrating an arrangement of a V-phase coil set according to the first embodiment of the present invention.

FIG. 5 is a schematic diagram illustrating an arrangement of a W-phase coil set according to the first embodiment of the present invention.

FIG. 6 is a schematic diagram illustrating a coil terminal arrangement according to the first embodiment of the present invention.

FIG. 7 is a schematic diagram illustrating a coil set according to a second embodiment of the present invention.

FIG. 8 is a schematic diagram illustrating an arrangement of a U-phase coil set according to the second embodiment of the present invention.

FIG. 9 is a schematic diagram illustrating an arrangement of a V-phase coil set according to the second embodiment of the present invention.

FIG. 10 is a schematic diagram illustrating an arrangement of a W-phase coil set according to the second embodiment of the present invention.

FIG. 11 is a schematic diagram illustrating a coil terminal arrangement according to the second embodiment of the present invention.

### DESCRIPTION OF EMBODIMENTS

Hereinafter, embodiments of the present invention will be described with reference to the drawings.

Note that, in the following description, a motor for electric power steering (EPS) of an automobile is used as an example of a rotary electric machine. In addition, in the following description, an “axial direction” refers to a direction along a rotational axis of the rotary electric machine. A circumferential direction refers to a direction along a rotational direction of the rotary electric machine. A “radial direction” refers to a radius vector direction (direction of radius) of when the rotational axis of the rotary electric machine is the center. An “inner circumferential side” refers to a radial direction inner side (inner diameter side), and an “outer circumferential side” refers to an opposite direction thereof, that is, a radial direction outer side (outer diameter side).

### First Embodiment

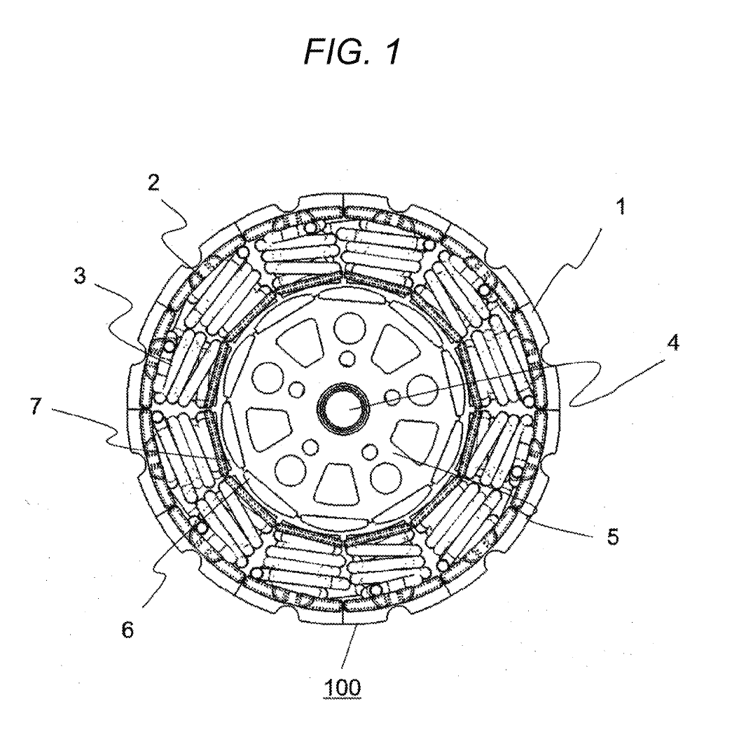

FIG. 1 is a cross-sectional view of a rotary electric machine 100. The rotary electric machine 100 is a brushless motor of 10 poles and 12 slots (the number of magnetic poles of the rotor is 10, and the number of slots of the stator is 12) of an inner rotor type in which a rotor is arranged on the inner circumferential side of a stator. In the rotor, a rotor core 5 is fixed to a shaft 4, and magnets 6 are arranged on the outer circumferential side of the rotor core 5. Further, on the outer circumferential side of the magnets 6, a magnet cover 7 is arranged to prevent the magnets 6 from scattering. The stator has a configuration in which a bobbin 2 for insulation is mounted to a stator core 1 consisting of a plurality of split cores, and a coil 3 is wound.

The present invention can be applied to a case where the number of magnetic poles of the rotor is 4n or 8n, and the number of slots of the stator is 12n, or a case where the number of magnetic poles of the rotor is 10n or 14n, and the number of slots of the stator is 12n, where n is an integer of 1 or more.

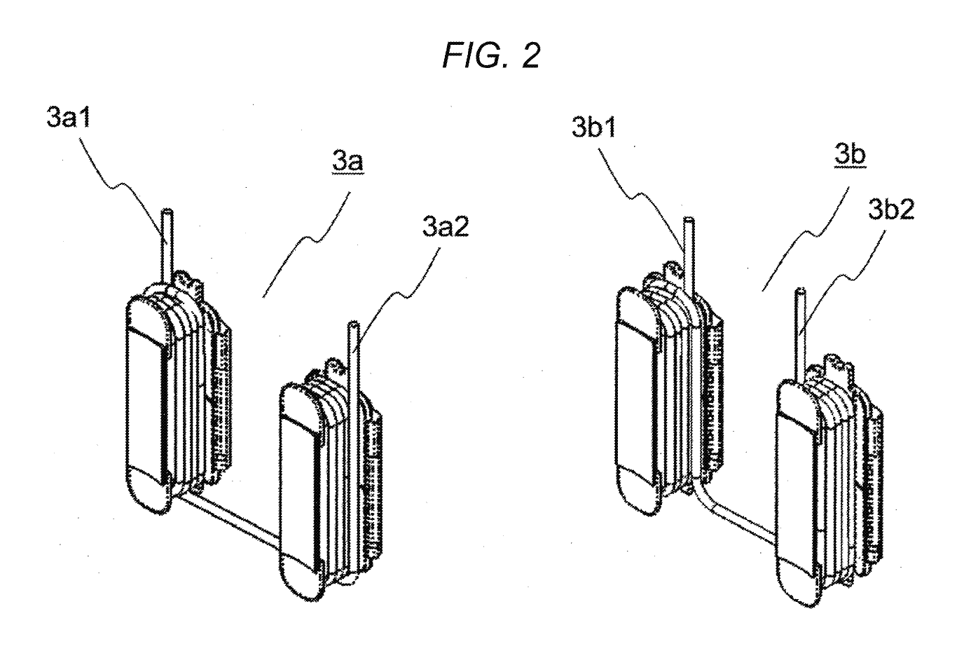

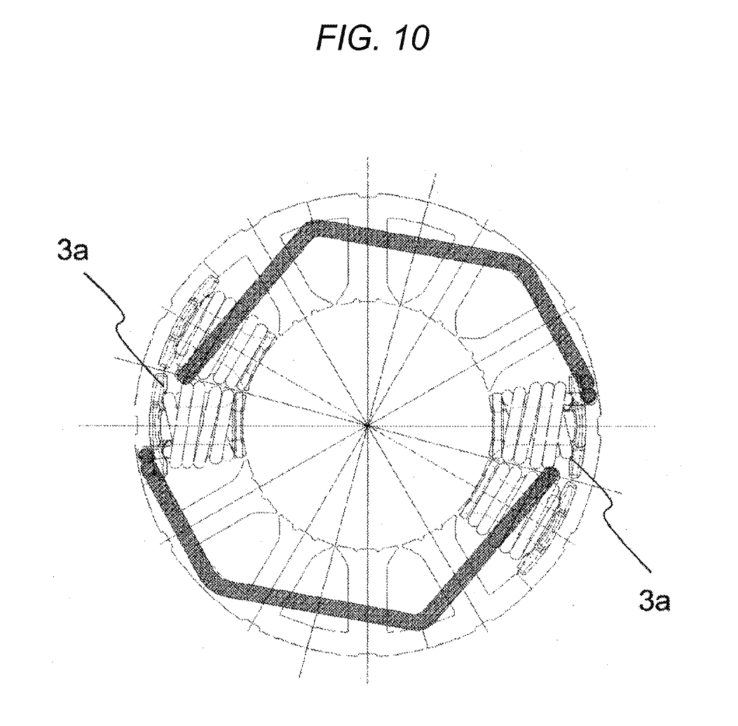

First, with reference to FIGS. 2 to 5, and 10, an example will be described of a brushless motor of 8 poles and 12 slots in a case where the number of magnetic poles of the rotor is 4n or 8n and the number of slots of the stator is 12n, where n is an integer of 1 or more.

FIG. 2 illustrates a first coil set 3a and a second coil set 3b. Each of the first coil set 3a and the second coil set 3b is a duplex coil set in which the coil 3 is continuously wound around two split cores. In the first coil set 3a, the winding start and the winding end of the coil 3 are made on the circumferential direction outer side of the two split cores. In the figure, the winding start is illustrated as a first coil terminal 3a1, and the winding end is illustrated as a second coil terminal 3a2. In the second coil set 3b, the winding start and the winding end of the coil 3 are made on the circumferential direction inner side of the two split cores. In the figure, the winding start is illustrated as a first coil terminal 3b1, and the winding end is illustrated as a second coil terminal 3b2. In addition, the first coil set 3a and the second coil set 3b have respective winding directions opposite from each other of the winding direction of the coil 3 with respect to the split core. Although not illustrated in FIG. 2, a routing portion is formed to each of the second coil terminal 3a2 of the first coil set 3a and the second coil terminal 3b2 of the second coil set 3b that are the winding ends.

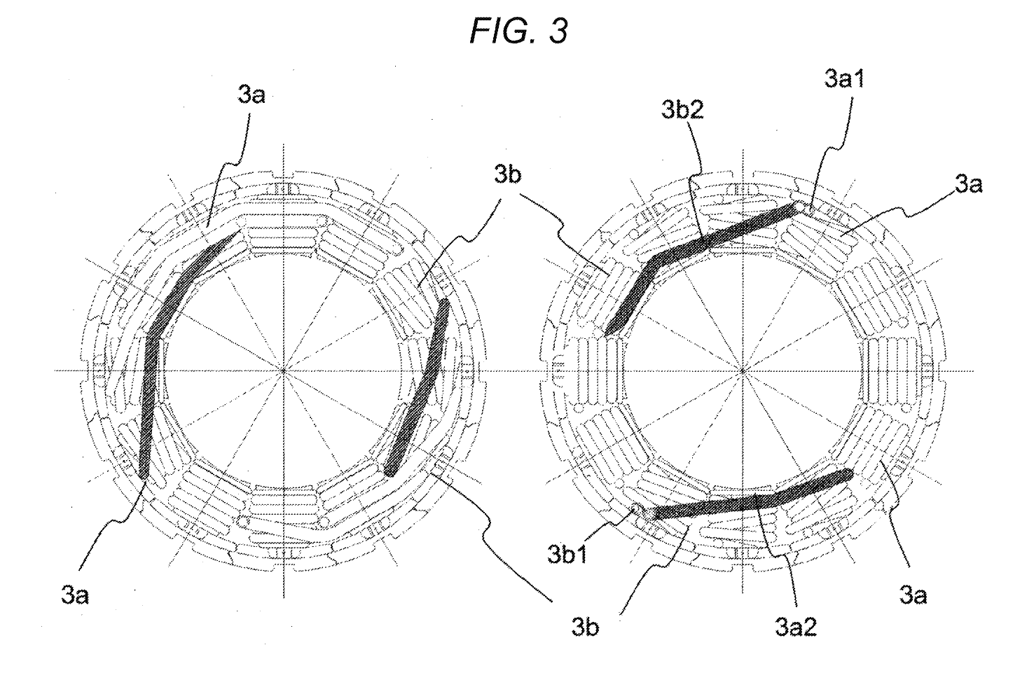

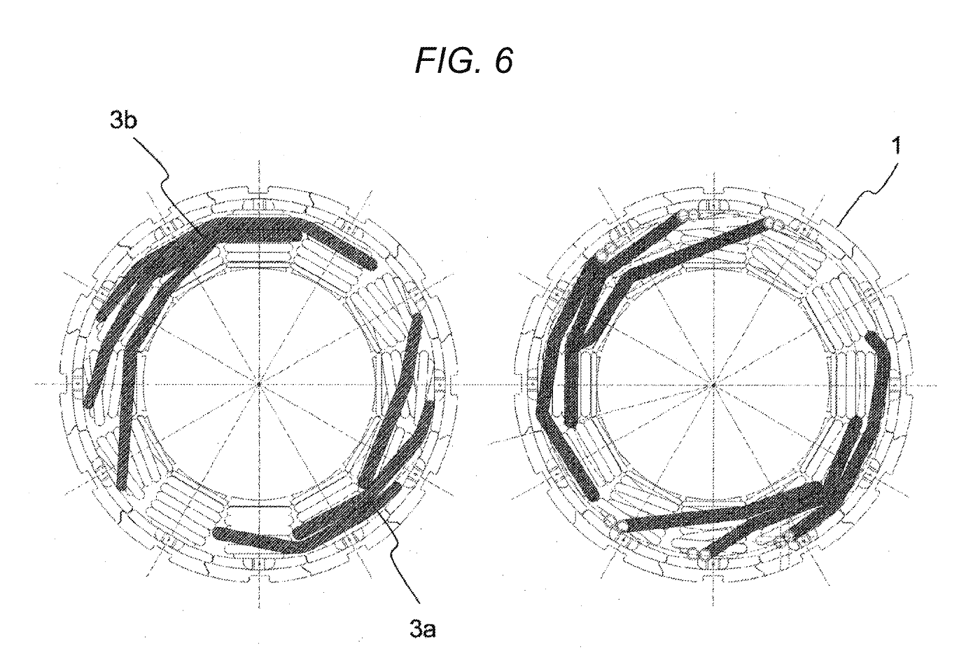

FIGS. 3 to 5 illustrate arrangements of the first coil set 3a and the second coil set 3b in the U-phase, the V-phase, and the W-phase, respectively. FIG. 6 illustrates a state in which the arrangements of the coil terminals of the U, V, and W-phases in FIGS. 3 to 5 are integrated together. In each of FIGS. 3 to 6, the left side diagram illustrates a diagram of a coil end of the rotary electric machine 100 viewed from an axial direction one side, and the right side diagram illustrates a diagram viewed from an axial direction other side. The coil terminals of the first coil set 3a and the second coil set 3b are located at the coil end illustrated in the right side diagram.

In the entire rotary electric machine 100, 3n first coil sets 3a and 3n second coil sets 3b are provided. In a case where the number of slots of the stator is 12 (that is, n=1), three first coil sets 3a and three second coil sets 3b are provided.

In each of the U, V, and W-phases, one coil of the first coil set 3a is wound around the third tooth counted from a tooth around which the other coil is wound. The same applies to the second coil set 3b. In addition, the first coil set 3a and the second coil set 3b are arranged diagonally with respect to the axis center (the center when the stator core 1 is viewed in the axial direction) as a reference.

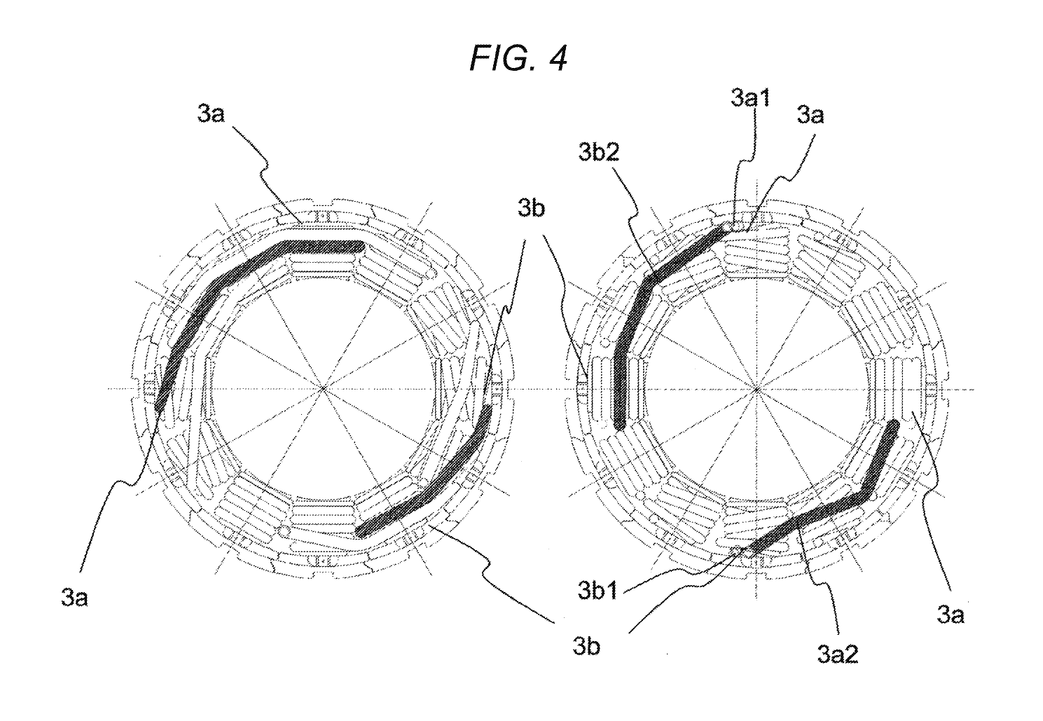

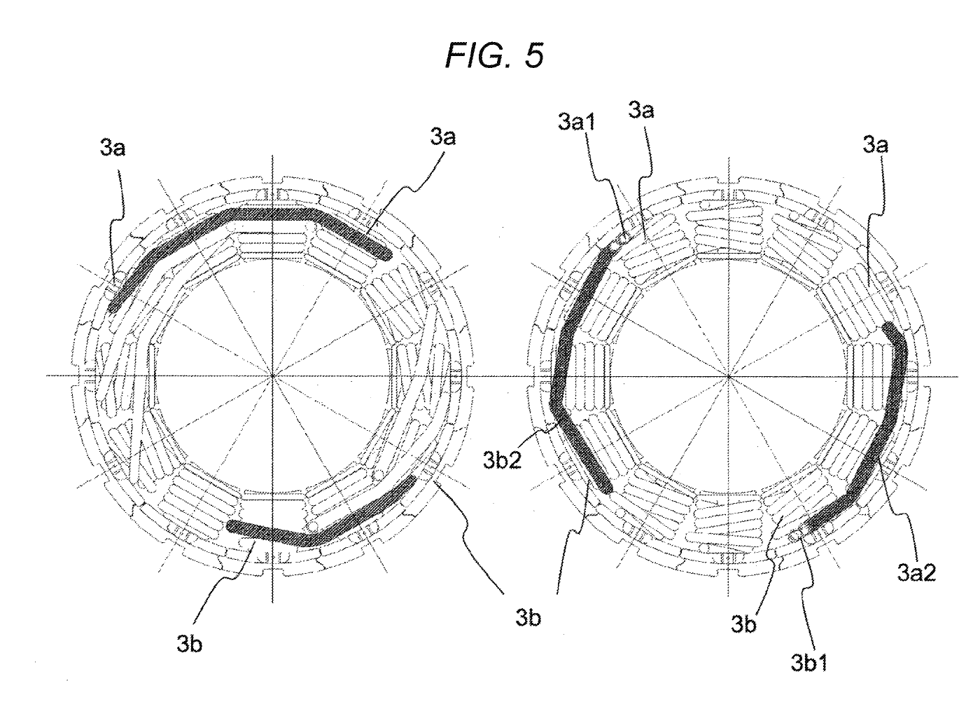

An example will be described with reference to FIG. 3. In the diagram illustrated on the left side of FIG. 3, the teeth (that is, the split cores) are numbered as the first, second, . . . , twelfth in the clockwise direction starting from the one on the upper side of the page. The first coil set 3a is wound around the ninth and twelfth teeth. The second coil set 3b is wound around the third and sixth teeth. Similarly, in FIG. 4, the first coil set 3a is wound around the tenth and first teeth, and the second coil set 3b is wound around the fourth and seventh teeth. In FIG. 5, the first coil set 3a is wound around the eleventh and second teeth, and the second coil set 3b is wound around the fifth and eighth teeth.

In any of the U, V, and W-phases illustrated in FIGS. 3 to 5, as illustrated in the right side diagram of each of FIGS. 3 to 5, the first coil terminal 3a1 at the winding start of the first coil set 3a is directly connected to the second coil terminal 3b2, to which the routing portion (shaded portion in the right side diagram) is formed, at the winding end of the second coil set 3b. In addition, the first coil terminal 3b1 at the winding start of the second coil set 3b is directly connected to the second coil terminal 3a2, to which the routing portion (shaded portion in the right side diagram) is formed, at the winding end of the first coil set 3a.

As illustrated in FIG. 6, in each of the first coil set 3a and the second coil set 3b, the shape of the routing portion of the coil terminal at the winding end is the same. Thus, it is possible to easily form the routing portion. In addition, since it is not necessary to cause the routing portions to cross each other, it is possible to arrange the routing portions in a plane, and as a result, the size (coil end height) can be reduced in the axial direction.

Further, since the winding directions of the first coil set 3a and the second coil set 3b are opposite from each other, it is possible to arrange the output terminal and the neutral point terminal diagonally with respect to the axis center, and an area necessary for providing the output terminal can be downsized.

### Second Embodiment

Next, an example will be described of a brushless motor of 10 poles and 12 slots in a case where the number of magnetic poles of the rotor is 10n or 14n and the number of slots of the stator is 12n, where n is an integer of 1 or more.

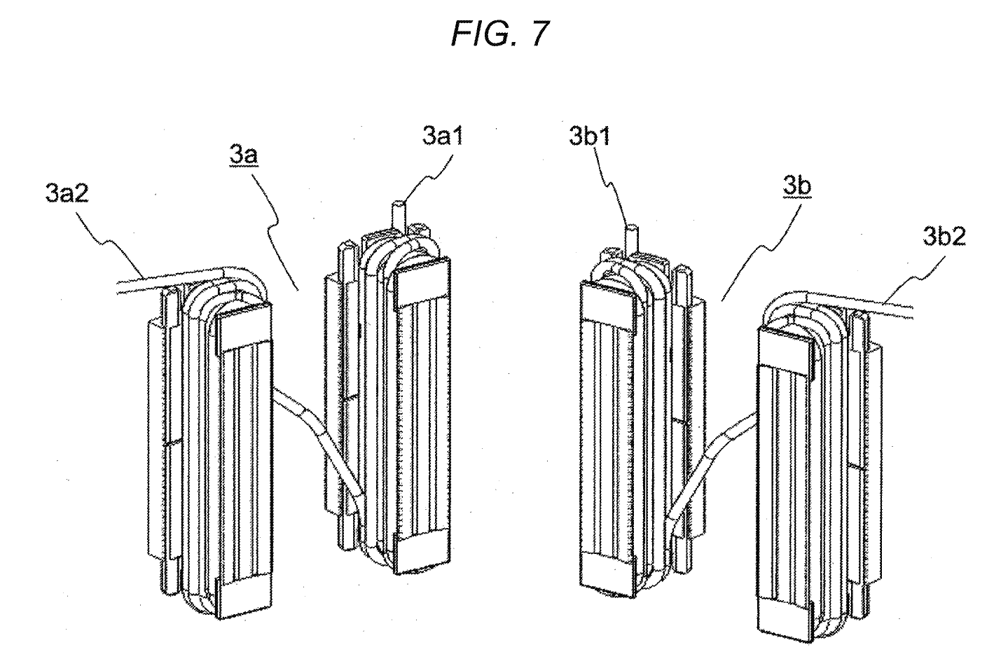

FIG. 7 illustrates a first coil set 3a and a second coil set 3b of the present embodiment. Each of the first coil set 3a and the second coil set 3b is a duplex coil set in which the coil 3 is continuously wound around two split cores. In both of the first coil set 3a and the second coil set 3b, the winding start is made on the circumferential direction outer side of the two split cores, and the winding end is made on the circumferential direction inner side of the split cores. In the figure, the winding start of the first coil set 3a is illustrated as a first coil terminal 3a1, the winding end is illustrated as a second coil terminal 3a2, the winding start of the second coil set 3b is illustrated as a first coil terminal 3b1, and the winding end is illustrated as a second coil terminal 3b2. In addition, the first coil set 3a and the second coil set 3b have respective winding directions opposite from each other of the winding direction of the coil 3 with respect to the split core.

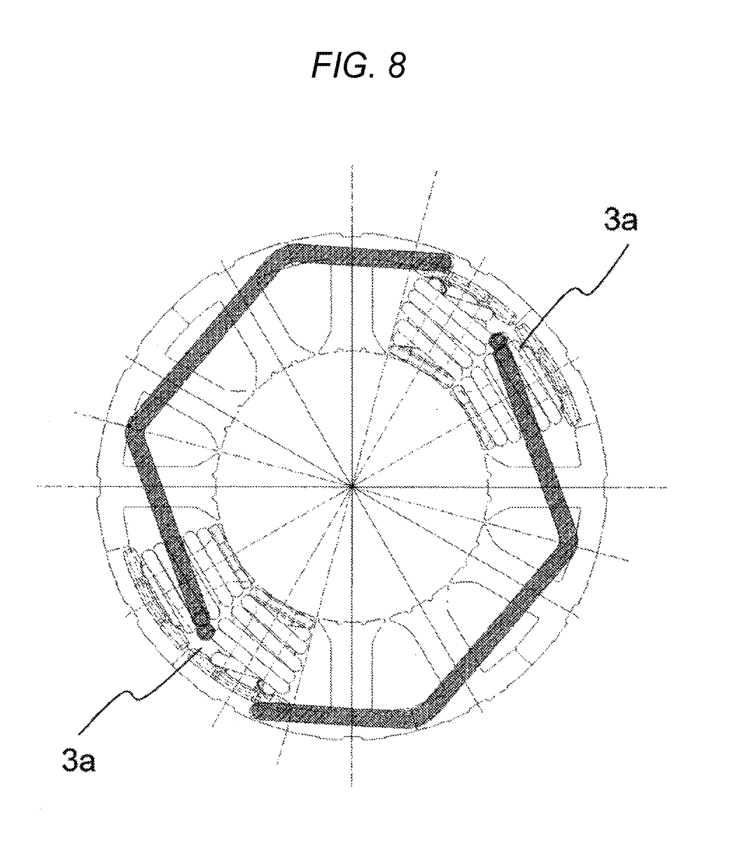

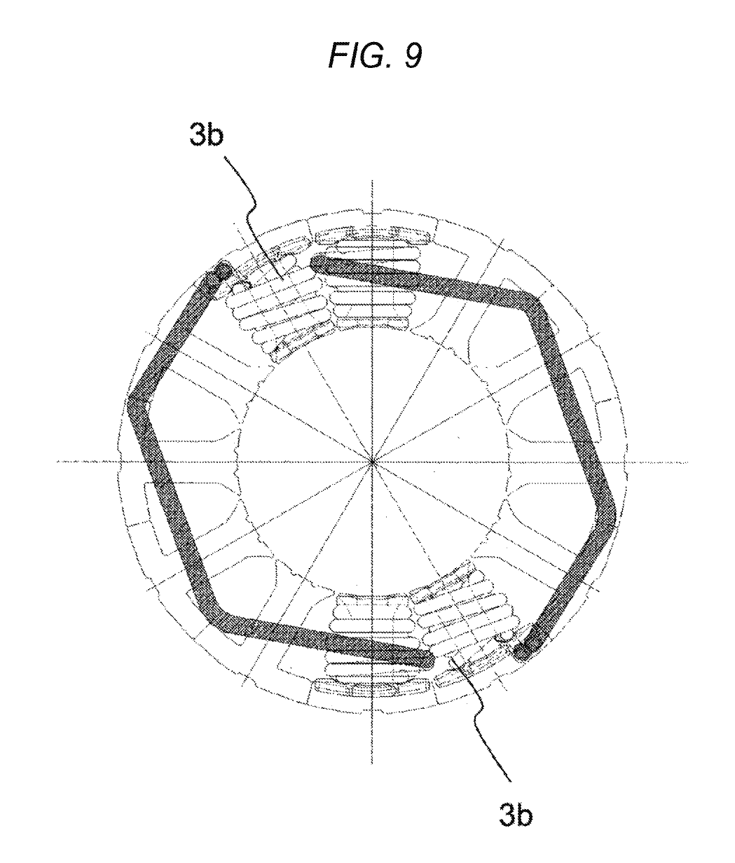

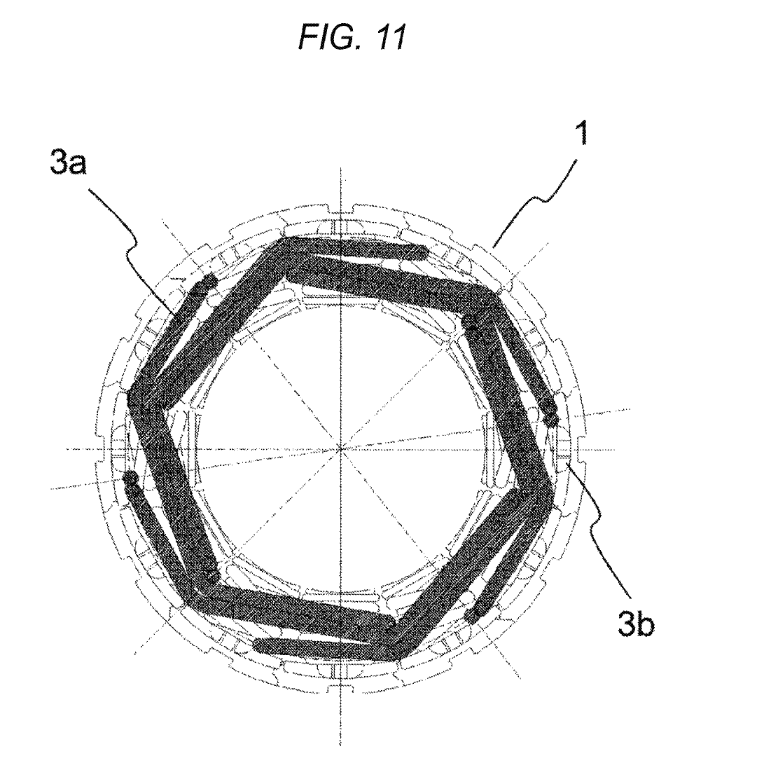

FIGS. 8 to 10 illustrate arrangements of the first coil set 3a and the second coil set 3b in the U-phase, the V-phase, and the W-phase, respectively. FIG. 11 illustrates a state in which the arrangements of the coil terminals of the U, V, and W-phases in FIGS. 8 to 10 are integrated together. Each of FIGS. 8 to 11 is a state viewed from the coil end side where the coil terminals of the first coil set 3a and the second coil set 3b are located.

In the entire rotary electric machine 100, a ratio of the number of the first coil sets 3a to the number of the second coil sets 3b is the first coil set 3a: the second coil set 3b=4n:2n (n is an integer of 1 or more). That is, the rotary electric machine 100 includes 4n first coil sets each having the routing portion formed to the second coil terminal 3a2, and 2n second coil sets each having the routing portion formed to the second coil terminal 3b2.

One coil of the first coil set 3a is wound around a tooth adjacent to a tooth around which the other coil is wound. The same applies to the second coil set 3b. In addition, the first coil set 3a and the second coil set 3b are arranged adjacent to each other.

The first coil terminal 3a1 of the first coil set 3a is directly connected to the second coil terminal 3a2 to which the routing portion of the other first coil set 3a is formed. The first coil terminal 3b1 of the second coil set 3b is directly connected to the second coil terminal 3b2 to which the routing portion of the other second coil set 3b is formed, and all the second coil sets 3b are electrically in-phase. The routing portions of the coil sets of the 4n first coil sets are made to have the same shape, and the routing portions of the coil sets of the 2n second coil sets are made to have the same shape. Thus, since it is not necessary to cause the routing portions to cross each other, it is possible to arrange the routing portions in a plane, and as a result, the size (coil end height) can be reduced in the axial direction.

Further, since the winding directions of the first coil set 3a and the second coil set 3b are opposite from each other, and a combination is adopted of the first coil set 3a: the second coil set 3b=4n:2n, it is possible to arrange the output terminal and the neutral point terminal diagonally with respect to the axis center, and an area necessary for providing the output terminal can be downsized.

Note that, the present invention is not limited to the embodiments described above, and includes various modifications. For example, the embodiments described above have been described in detail for describing the present invention clearly, and are not necessarily limited to those including all the configurations described. For a part of the configuration of each embodiment, it is possible to add, remove, and replace another configuration.

### REFERENCE SIGNS LIST

100 rotary electric machine
1 stator core
2 bobbin
3 coil
3a first coil set
3b second coil set
3a1, 3b1 first coil terminal
3a2, 3b2 second coil terminal
4 shaft
5 rotor core
6 magnet
7 magnet cover

1. A rotary electric machine comprising
a rotor and a stator,
the stator including teeth each wound with a coil, wherein
the coil consists of a first coil set and a second coil set,
each of the first coil set and the second coil set is continuously wound around the two teeth, and includes a first coil terminal, and a second coil terminal to which a routing portion is formed,
the first coil terminal of each of the first coil set and the second coil set is directly connected to the second coil terminal of another of the first coil set and the second coil set,
the first coil terminal and the second coil terminal of each of the first coil set and the second coil set are arranged on an identical coil end, and
the second coil terminal of each of the first coil set and the second coil set is arranged not to cross any other coil terminal in an axial direction.

2. The rotary electric machine according to claim 1, wherein
a number of magnetic poles of the rotor is 4n or 8n, and a number of slots of the stator is 12n, where n is an integer of 1 or more,
3n pieces of the first coil sets are included, and 3n pieces of the second coil sets are included,
in each of the first coil set and the second coil set, one coil is wound around a third tooth counted from a tooth around which another coil is wound,
in the first coil set, the first coil terminal and the second coil terminal are arranged in a circumferential direction outer side of the first coil set,
in the second coil set, the first coil terminal and the second coil terminal are arranged in a circumferential direction inner side of the second coil set,
the first coil terminal of the first coil set and the second coil terminal of the second coil set are directly connected together, and
the second coil terminal of the first coil set and the first coil terminal of the second coil set are directly connected together.

3. The rotary electric machine according to claim 1, wherein
a number of magnetic poles of the rotor is 10n or 14n, a number of slots of the stator is 12n, where n is an integer of 1 or more,
4n pieces of the first coil sets are included, and 2n pieces of the second coil sets are included,
the first coil terminal of the first coil set is directly connected to the second coil terminal of another first coil set, and
the first coil terminal of the second coil set is directly connected to the second coil terminal of another second coil set and all the second coil sets are electrically in-phase.
